(19) United States
(12) Patent Application Publication
(10) Pub. No.: US 2004/0236921 A1
(43) Pub. Date: Nov. 25, 2004

(54) Method to improve bandwidth on a cache data bus

(76) Inventor: Kuljit S. Bains, Olympia, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/442,334

(22) Filed: May 20, 2003

(51) Int. Cl. G06F 12/00

(52) U.S. Cl. 711/168; 711/118

(57) ABSTRACT

Efficiently utilizing bandwidth by reading a first subset of a cache line in one clock cycle range, while reading a second subset of the cache line in a second clock cycle range For example, the cache line is “split” into two equal parts, a first part of the cache line is read in a first clock cycle range, while the second part is read in the second clock cycle range. Alternatively, reordering the read or write transactions to efficiently utilize bandwidth on the data bus

### RELATED APPLICATION

This application is related to application Ser. No. ______, entitled “A Method for opening Pages of Memory with a Single Command””, filed concurrently and assigned to the assignee of the present application. Likewise, this application is related to application Ser. No. ______, entitled “A HIGH SPEED DRAM CACHE ARCHITECTURE” filed previously and assigned to the assignee of the present application.

### BACKGROUND

1. Field

The present disclosure pertains to the field of cache memories. More particularly, the present disclosure pertains to a new method for improving bandwidth on a cache data bus for read and/or write operations.

2. Description of Related Art

Cache memories generally improve memory access speeds in computer or other electronic systems, thereby typically improving overall system performance. Increasing either or both of cache size and speed tend to improve system performance, making larger and faster caches generally desirable. However, cache memory is often expensive, and generally costs rise as cache speed and size increase. Therefore, cache memory use typically needs to be balanced with overall system cost.

Traditional cache memories utilize static random access memory (SRAM), a technology which utilizes multi-transistor memory cells. In a traditional configuration of an SRAM cache, a pair of word lines typically activates a subset of the memory cells in the array, which drives the content of these memory cells onto bit lines. The outputs are detected by sense amplifiers. A tag lookup is also performed with a subset of the address bits. If a tag match is found, a way is selected by a way multiplexer (mux) based on the information contained in the tag array.

A DRAM cell is typically much smaller than an SRAM cell, allowing denser arrays of memory and generally having a lower cost per unit. Thus, the use of DRAM memory in a cache may advantageously reduce per bit cache costs. One prior art DRAM cache performs a full hit/miss determination (tag lookup) prior to addressing the memory array. In this DRAM cache, addresses received from a central processing unit (CPU) are looked up in the tag cells. If a hit occurs, a full address is assembled and dispatched to an address queue, and subsequently the entire address is dispatched to the DRAM simultaneously with the assertion of load address signal.

FIG. 1 illustrates a timing diagram for back to back reads of a memory. For example, the horizontal axis depicts clock cycles, such as, 0, 1, 2, . . . 29, and 30. The vertical axis depict a command clock, CMDCLK, a command instruction, CMD, an Address, ADR, for a read or write, and an output, DQ[35:0]. As a result of back to back reads, there are clock cycles 19-23 that are not utilized as the memory outputs the data for the second read of Row 5, Column 3 of banks 0 and 1, respectively. One reason for this inefficient use is a timing restriction, Tccd, which is for back to back accesses to the same memory bank. Thus, the bandwidth is inefficiently utilized on a data bus because the output on DQ pins for clock cycles 19-23 are idle. Likewise, the same problem exists for back to back writes to the same memory bank pair.

### BRIEF DESCRIPTION OF THE FIGURES

The present invention is illustrated by way of example and not limitation in the Figures of the accompanying drawings.

FIG. 1 illustrates a prior art of a timing diagram for back to back reads to a memory.

FIG. 2 illustrates an apparatus utilized in an embodiment depicted in FIG. 3.

FIG. 3 illustrates a method for a timing diagram for a read of a cache memory according to one embodiment.

FIG. 4 illustrates a method for a timing diagram for a read of a cache memory according to one embodiment.

FIG. 5 is an apparatus according to one embodiment.

### DETAILED DESCRIPTION

The following description provides methods for improving bandwidth efficiency on a data bus for a high speed cache architecture. In the following description, numerous specific details are set forth in order to provide a more thorough understanding of the present invention. It will be appreciated, however, by one skilled in the art that the invention may be practiced without such specific details. Those of ordinary skill in the art, with the included descriptions, will be able to implement appropriate logic circuits without undue experimentation.

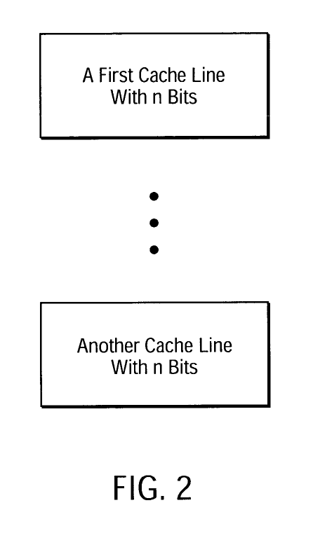

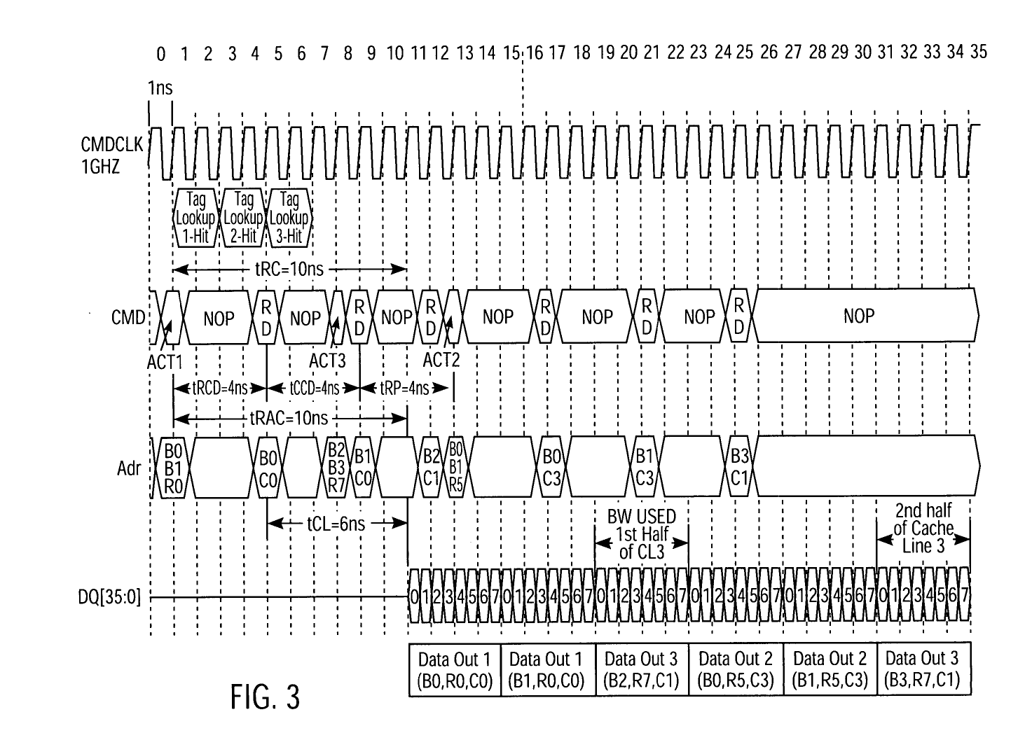

Various embodiments disclosed may allow a memory such as a DRAM memory to be efficiently used as cache memory. Some embodiments provide particular timing diagrams to efficiently utilize bandwidth on a data bus that may be advantageous in particular situations. In one embodiment, the claimed subject matter efficiently utilizes bandwidth by reading a first subset of a cache line in one clock cycle range, while reading a second subset of the cache line in a second clock cycle range For example, the cache line is “split” into two equal parts, a first part of the cache line is read in a first clock cycle range, while the second part is read in the second clock cycle range. This embodiment is discussed further in connection with FIGS. 2 and 3, respectively.

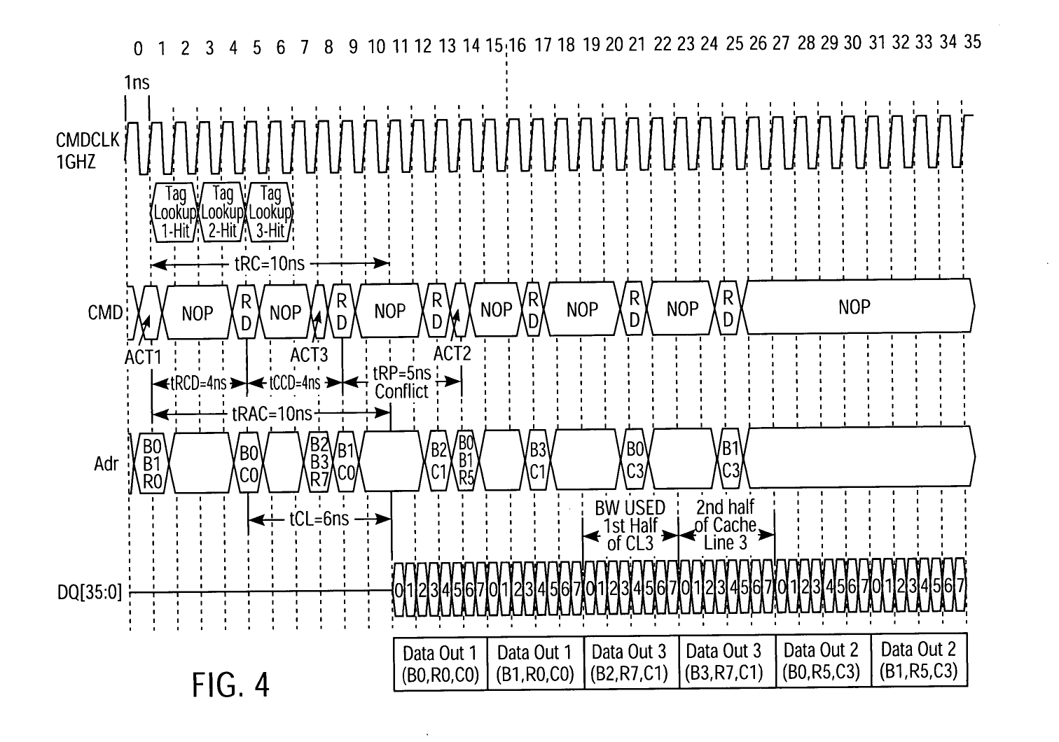

Alternatively, another embodiment does not split the cache lines. In contrast, this embodiment reorders the read or write transactions to efficiently utilize bandwidth on the data bus and is discussed further in connection with FIG. 4.

The term DRAM is used loosely in this disclosure as many modern variants of the traditional DRAM memory are now available. The techniques disclosed and hence the scope of this disclosure and claims are not strictly limited to any specific type of memory, although single transistor, dynamic capacitive memory cells may be used in some embodiments to provide a high density memory array. Various memories arrays which allow piece-wise specification of the ultimate address may benefit from certain disclosed embodiments, regardless of the exact composition of the memory cells, the sense amplifiers, any output latches, and the particular output multiplexers used.

FIG. 2 illustrates an apparatus utilized in an embodiment depicted in FIG. 3. In one embodiment, the apparatus is a plurality of cache lines in a memory comprising n bits, wherein n is greater than zero. In this embodiment, the n bits are sixteen bits that are encompassed within two banks of a memory. Alternatively, in another embodiment, the n bits of the cache line are encompassed within a single bank of memory. In the same embodiment, the memory is a DRAM utilized for a cache.

However, the claimed subject matter is not limited to sixteen bits. For example, the claimed subject matter supports different sizes of a cache line based at least in part on the memory architecture, size of the cache data bus, etc.

As further discussed in connection with FIG. 3, the cache line depicted in FIG. 2 will be read in two different clock cycle ranges. For example, a first part of the cache line is read in a first clock cycle range, while the second part is read in the second clock cycle range. In one embodiment, the first part of the cache line and the second part of the cache line are identical in size. For example, for the embodiment of 16 bits for the cache line, the first 8 bits of the cache line are read during the first clock cycle range, and the second 8 bits of the cache line are read during the second clock cycle range.

FIG. 3 illustrates a timing diagram for a read of a cache memory according to one embodiment. The timing diagram illustrates a horizontal axis and a vertical axis. The horizontal axis depicts clock cycles, such as, 0, 1, 2, . . . 29, and 30. The vertical axis depict a command clock, CMDCLK, a command instruction, CMD, an Address, ADR, for a read or write, and an output, DQ[35:0]. However, the claimed subject matter is not limited to these pin designations. For example, the claimed subject matter supports different numbers of output pins, such as, DQ[0:15], DQ[63:0], etc, as the memory applications progress or are backward compatible.

In one embodiment, a first tag lookup for a memory bank pair is performed for the first cache line during clock cycles 1-2 which results in a hit to a memory bank pair 0-1. Subsequently, a second tag lookup to the same memory bank pair is performed for the next access during clock cycles 3-4. A third tag lookup is performed to a different memory bank pair during clock cycles 5-6 that results in a hit to bank pair 2-3 that results in a read of the first half of the cache line in bank 2 during clock cycles 19-22. However, the second half of the cache line is read after the access to bank pair 0-1 for second tag lookup.

In contrast to the previous embodiment, a different embodiment comprises a first tag lookup for a memory bank pair is performed for the first cache line during clock cycles 1-2 which results in a hit to a memory bank pair 0-1. Subsequently, a second tag lookup to the same memory bank pair is performed for the next access during clock cycles 3-4. A third tag lookup is performed to the same memory bank pair during clock cycles 5-6. Eventually, a fourth tag lookup is performed to a different memory bank pair that results in a hit to bank pair 2-3(in one embodiment) that results in a read of the first half of the cache line in bank 2 during clock cycles 19-22. However, the second half of the cache line is read after the access to bank pair 0-1 for second tag lookup.

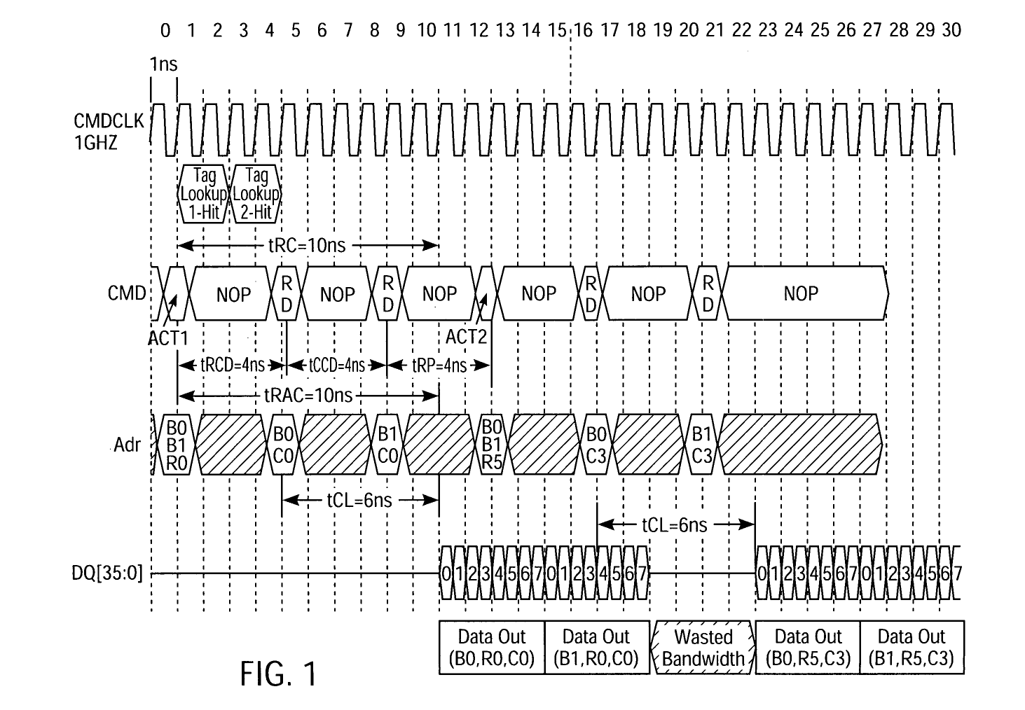

The claimed subject matter efficiently utilizes bandwidth by reading a first subset of a cache line in one clock cycle range, while reading a second subset of the cache line in a second clock cycle range For example, the cache line is “split” into two equal parts, a first part of the cache line is read in a first clock cycle range, while the second part is read in the second clock cycle range. In one embodiment, the cache line is 16 bits and is encompassed across two memory banks. As illustrated in the timing diagram, the first part of the cache line (in this illustrated, the cache line is designated as “CL3”) is read during clock cycles 19-23, in contrast, the second part of the cache line is read during clock cycles 31-35. Thus, as compared to FIG. 1, the clock cycles 19-23 are efficiently utilized to output the read of the first part of cache line 3.

FIG. 4 illustrates a timing diagram for a read of a cache memory according to one embodiment. This timing diagram is an alternative embodiment that does not allow for “splitting a cache line” as depicted in connection with FIG. 3. In contrast, FIG. 4 reorders the read transactions to improve bandwidth efficiency by completing the read transaction out of order. For example, the timing diagram in one embodiment allows for the completion of the read operation of a cache line 3 to be processed before the read operation of a cache line 2.

As previously described, the timing diagram illustrates a horizontal axis and a vertical axis. The horizontal axis depicts clock cycles, such as, 0, 1, 2, . . . 29, and 30. The vertical axis depict a command clock, CMDCLK, a command instruction, CMD, an Address, ADR, for a read or write, and an output, DQ[35:0].

In this timing diagram, the read operation for cache line 3 from memory bank pairs B2-B3, row 7, column 1, is completed before the read operation for cache line 2 from memory bank pairs B0-B1 for row 5, column 3. Specifically, the cache line 3 read operation is output during clock cycles 19-26, while the cache line 2 read operation is output starting at clock cycle 27. Thus, when compared to FIG. 1, FIG. 4 allows efficient utilization of the bandwidth because clock cycles 19-23 are utilized to output the first half of cache line 3.

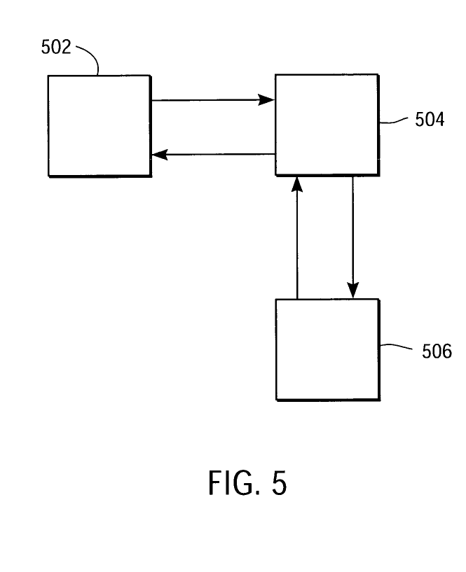

FIG. 5 depicts an apparatus in accordance with one embodiment. The apparatus in one embodiment is a processor 502 that incorporates a memory controller 504 that is coupled to a DRAM 506. For example, the processor incorporates a memory controller by allowing the processor to perform memory controller functions, thus, the processor performs memory controller functions. In contrast, in another embodiment, the processor 502 is coupled to a memory controller 504 that is coupled to a DRAM 506 and the processor does not perform memory controller functions. In both previous embodiments, the apparatus comprises the previous embodiments depicted in FIGS. 2-4 of the specification. Also, in one embodiment, the apparatus is a system.

Also, the DRAM may be a synchronous DRAM, a double data rate DRAM (DDR DRAM).

Thus, a high speed cache architecture is disclosed to improve efficiency on a data bus. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure.

What is claimed is:

1. An apparatus comprising:
a memory with a plurality of memory bank pairs, with each memory bank pair having a plurality of memory lines;
a processor, coupled to the memory, to issue a first memory operation to a first memory bank pair and to issue a second memory operation to the second memory bank pair; and
a memory controller, coupled to the memory, to process the first and second memory operation and the apparatus to perform a split of the memory line for either the first or second memory operation if the first and second memory operation were to different memory bank pairs.

2. The apparatus of claim 1 wherein the memory operation is either a read or write operation.

3. The apparatus of claim 2 wherein the split of the memory line is to read or write a first half of the memory line in a first clock cycle range and to read or write a second half of the memory line in a second clock cycle range.

4. The apparatus of claim 3 wherein the read or write of the second half of the memory line does not follow the read or write of the first half of the memory line because there is a predetermined number of clock cycles between the first clock cycle range and second clock cycle range.

5. The apparatus of claim 1 wherein the memory is a dynamic random access memory (DRAM).

6. The apparatus of claim 5 wherein the DRAM is utilized as a cache memory.

7. The apparatus of claim 1 wherein the split of the memory line comprises a sixteen bit memory line that is contained within two memory banks.

8. The apparatus of claim 1 wherein the number of memory bank pairs is either 4 or 8.

9. The apparatus of claim 1 wherein the processor is coupled to the memory controller.

10. The apparatus of claim 1 wherein the processor incorporates the memory controller.

11. An apparatus comprising:
a memory with a plurality of memory bank pairs, with each memory bank pair having a plurality of memory lines;
a processor, coupled to the memory, to issue a first memory operation to a first memory bank pair and to issue a second memory operation to the second memory bank pair; and
the apparatus to process the first and second memory operation and the apparatus to perform to reorder the first and second memory operation and execute them out of order if the first and second memory operation were to different memory bank pairs.

12. The apparatus of claim 11 wherein the memory operation is either a read or write operation.

13. The apparatus of claim 11 wherein the reorder of the first and second memory operation allows for the second memory operation to be completed and output on a plurality of output pins, DQ, before the first memory operation is completed and output on the plurality of output pins, DQ.

14. The apparatus of claim 11 wherein the memory is a dynamic random access memory (DRAM).

15. The apparatus of claim 14 wherein the DRAM is utilized as a cache memory.

16. The apparatus of claim 11 wherein first and second memory operation comprises a read or write of sixteen bits to one of the plurality of memory line that is contained across two memory banks.

17. The apparatus of claim 11 wherein the number of memory bank pairs is either 4 or 8.

18. A method comprising:
generating a first memory operation for a first memory line of a first memory bank pair;
generating a second memory operation for a second memory line of a second memory bank pair;
splitting of either the first or second memory line if the first and second memory operation were to different memory bank pairs.

19. The method of claim 18 wherein splitting the first or second memory line results in reading or writing to a first half of the first or second memory line in a first clock cycle range and reading or writing to a second half of the first or second memory line in a second clock cycle

20. A method comprising:
generating a first memory operation for a first memory line of a first memory bank pair;
generating a second memory operation for a second memory line of a second memory bank pair;
executing the first and second memory operation out of order if the first and second memory operation were to different memory bank pairs.

21. The method of claim 20 wherein executing comprises completing and outputting the second memory operation on a plurality of output pins, DQ, before the first memory operation is completed and output on the plurality of output pins, DQ.

22. A system comprising:
a processor to generate a first and second memory operation to a first and second cache line of a first and second memory bank pair; and
a synchronous dynamic random access memory to execute the first and second memory operation if the first and second memory bank pairs are different to either:
allow splitting of either the first and second memory line; or
execute the first and second memory operation out of order.

23. The system of claim 22 wherein the synchronous DRAM is utilized as a cache memory.

24. The system of claim 22 wherein the split of the memory line comprises a sixteen bit memory line that is contained within two memory banks.

25. The system of claim 22 wherein the number of memory bank pairs is either 4 or 8.

26. The system of claim 22 wherein the processor is coupled to a memory controller.

27. The system of claim 22 wherein the processor incorporates the functions of a memory controller.
